(19) United States
(12) Patent Application Publication
(10) Pub. No.: US 2026/0143078 A1
(43) Pub. Date: May 21, 2026

(54) IMAGE FORMING APPARATUS AND IMAGE READING APPARATUS

(71) Applicant: CANON KABUSHIKI KAISHA, Tokyo (JP)

(72) Inventor: AKIRA URITA, Ibaraki (JP)

(21) Appl. No.: 19/382,080

(22) Filed: Nov. 6, 2025

(30) Foreign Application Priority Data
Nov. 15, 2024 (JP) 2024-199918

(51) Int. Cl. H04N 1/23; G03G 15/00; G03G 15/22; G03G 21/16; H04N 1/10

(52) U.S. Cl. CPC H04N 1/2353; G03G 15/228; G03G 15/6552; G03G 21/1619; G03G 21/1652; H04N 1/1026

(57) ABSTRACT

An image forming apparatus includes a main apparatus for forming an image on a sheet and an image reading apparatus for reading an image on an original. The main apparatus includes a discharge tray on which the sheet, on which the image is formed, is stacked. The image reading apparatus includes a housing to accommodate a reading unit, a sensor disposed on a bottom surface of the housing and a cable connected to the sensor. A lower surface of the bottom surface is positioned above a discharge tray and forms an upper portion of a discharge space to which the sheet, on which the image is formed, is discharged. In a bottom surface of the housing, a groove which is recessed downward inside the housing and protrudes in the discharge space is formed. The cable is arranged to pass through inside the groove.

### BACKGROUND

### Field of the Technology

The present disclosure relates to an image reading apparatus which reads an image on a sheet and an image forming apparatus provided with the image reading apparatus.

### Description of the Related Art

Conventionally, as an image reading apparatus mounted on an image forming apparatus such as a copy machine, an apparatus which reads an image of an original stacked on an original table glass while a reading unit thereof is being moved in a sub scanning direction is known. In addition, in such an image reading apparatus, a size detecting sensor for determining a size of the original stacked on the original table glass is disposed under the original table glass (inside a housing of the image reading apparatus) is known (e.g., in Japanese Patent Application Laid-Open No. 2004-126247).

Inside such an image reading apparatus, a cable which transfers a signal of an image read by a reading unit and a cable which transfers a signal from the size detecting sensor are disposed. And these cables are routed along a bottom surface of the housing so as not to contact the reading unit upon the reading unit being moved.

By the way, some of an image forming apparatus provided with the image reading apparatus have a configuration in which an upper surface of a discharge space, to which a sheet on which the image has been formed is discharged, is constituted by a lower surface of the housing of the image reading apparatus. In such an image forming apparatus, in order to make it easier for a user to take out the sheet from a discharging portion (space), it is desirable to make the housing of the image reading apparatus smaller (thinner) in its height direction. However, in order the cables disposed on the bottom surface of the housing of the image reading apparatus not to contact the reading unit, a sufficient space should be secured between an area in which the reading unit is moved and the cables, so that the conventional housing of the image reading apparatus is large in its height direction. As a result, the space in the discharging portion of the image forming apparatus becomes narrower, and there is a problem that it is difficult for a user to take out the sheet from the discharging portion.

### SUMMARY

Therefore, the present disclosure provides advantageous solutions, in an image forming apparatus in which an upper surface of a discharging portion is constituted by a lower surface of an image reading apparatus, to make it easier for a user to take out a sheet from the discharging portion.

According to some embodiments of the present disclosure, an image forming apparatus includes a main apparatus configured to form an image on a sheet; and an image reading apparatus configured to read an image on an original, wherein the main apparatus is provided with an image forming unit configured to form the image on the sheet, and a discharge tray on which the sheet, on which the image is formed by the image forming unit, is stacked, wherein the image reading apparatus is provided with a transparent member on which the original is stacked, a reading unit configured to read the image of the original stacked on the transparent member, a housing configured to support the transparent member and to accommodate the reading unit, a sensor disposed on a bottom surface of the housing and configured to detect the original stacked on the transparent member, and a cable connected to the sensor, wherein a lower surface of the bottom surface is positioned above the discharge tray and forms an upper portion of a discharge space to which the sheet, on which the image is formed by the image forming unit, is discharged, wherein in the bottom surface of the housing, a groove portion which is recessed downward inside the housing and protrudes in the discharge space is formed, and wherein the cable is arranged to pass through inside the groove portion.

Further features of the present disclosure will become apparent from the following description of exemplary embodiments with reference to the attached drawings.

### BRIEF DESCRIPTION OF THE DRAWINGS

FIG. 1 is a cross-sectional outline view of an image forming apparatus.

FIG. 2 is a schematic view of the image forming apparatus as viewed from a back side of the apparatus.

FIG. 3 is a perspective view of an image reading apparatus.

FIG. 4 is a perspective view of an image reading main apparatus.

FIG. 5 is a perspective view of the image reading main apparatus in a state in which a top cover thereof is removed.

FIG. 6 is a perspective view of a size detecting sensor.

FIG. 7 is a perspective view of a sensor cable and a cable guide.

FIG. 8 is a cross-sectional view of a discharging portion of the image forming apparatus and the image reading main apparatus.

FIG. 9 is a cross-sectional view illustrating a groove portion and a flat cable of the image reading apparatus.

FIG. 10 is a cross-sectional view illustrating a recessed portion and a driving motor of the image reading apparatus.

### DESCRIPTION OF THE EMBODIMENTS

Hereinafter, an image reading apparatus and an image forming apparatus according to various exemplary embodiments, features, and aspects of the present disclosure will be described with reference to the drawings. Dimensions, material, shapes, relative arrangement, etc. of constituting components described in the embodiments below are, unless otherwise specifically described in particular, not intended to limit the scope of application of the present art only thereto.

### Outline Configuration of an Image Forming Apparatus

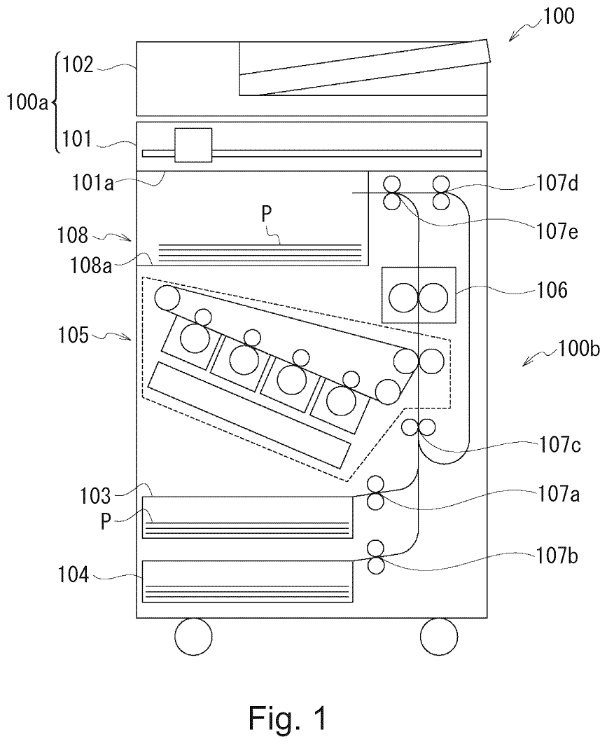

First, an outline configuration of an image forming apparatus 100 according to the present embodiment will be described using FIG. 1. FIG. 1 is a schematic cross-sectional view illustrating the image forming apparatus 100 according to the present embodiment. Incidentally, in the description below, a position at which a user is facing an unshown operating portion is referred to as a front side of the image forming apparatus 100, and an opposite side thereof is referred to as a back side. In addition, a direction going from the front side to the back side as the image forming apparatus 100 is viewed from the front side is referred to as a depth direction, and a direction perpendicular to the depth direction and a vertical direction is referred to as a left-right direction.

As shown in FIG. 1, the image forming apparatus 100 is provided with an image reading apparatus 100a, which reads an image of an original, and an image forming main apparatus, which forms the image on a sheet P. The image reading apparatus 100a is provided with an image reading main apparatus 101 which reads the image of the original and an automatic document feeding apparatus (hereinafter, referred to as “ADF”) 102 which conveys the original to the image reading main apparatus 101, and is disposed above the image forming main apparatus 100b. Incidentally, the image forming apparatus 100 shown in FIG. 1 is a laser beam printer of electrophotographic type, however, it may be an image forming apparatus using an inkjet type or other image forming methods as an image forming means.

The image forming main apparatus 100b is provided with cassettes 103 and 104, an image forming unit 105, a fixing portion 106 and a discharging portion 108. The cassettes 103 and 104 are sheet accommodating portions which accommodate the sheet P on which the image is formed. The sheets P accommodated in the cassettes 103 and 104 are fed by feeding rollers 107a and 107b, and conveyed to the image forming unit 105 by a conveyance roller pair 107c, respectively.

The image forming unit 105 is an image forming unit of electrophotographic type which is conventionally known and constituted by a laser scanner, a developing portion, an intermediary transfer belt, a secondary transfer roller, etc. The image forming unit 105 forms a full-color toner image with a developing portion thereof corresponding to each color of yellow (Y), magenta (M), cyan (C) and black (K), and transfers the toner image from the intermediary transfer belt to the sheet P with the secondary transfer roller.

The sheet P on which the toner image has been transferred by the image forming unit 105 is conveyed to the fixing portion 106. And by the sheet P being heated and pressed in the fixing portion 106, the toner image is fixed to the sheet P. In a case of a single-side printing, the sheet P to which the toner image has been fixed is discharged to the discharging portion 108 by a discharging roller pair 107e. In a case of a double-side printing, the sheet P to which the toner image has been fixed is switched back by the discharging roller pair 107e, and conveyed again toward the imaging forming unit 105 by a double-side conveyance roller pair 107d. Thereafter, the sheet P, of which the toner images have been formed on both sides, is discharged to the discharging portion 108 by the discharging roller pair 107e.

The image forming main apparatus 100b has a configuration of a so-called in-body discharging, which includes the discharging portion 108 in a housing. The discharging portion 108 includes a discharge tray 108a on which the sheet P discharged by the discharging roller pair 107e is stacked. A space in which the sheet P is stacked in the discharging portion 108 is formed by the discharge tray 108a and a lower surface 101a of the image reading main apparatus 101. More specifically, a lower surface of the discharge space of the discharging portion 108 is formed by the discharge tray 108a, and an upper surface thereof is formed by the lower surface 101a of the image reading main apparatus 101. And, the discharging portion 108 is open on the front side and a left side of the image forming apparatus 100. Therefore, a user, standing on the front side of the image forming apparatus 100, can take out the sheet P from the discharging portion 108.

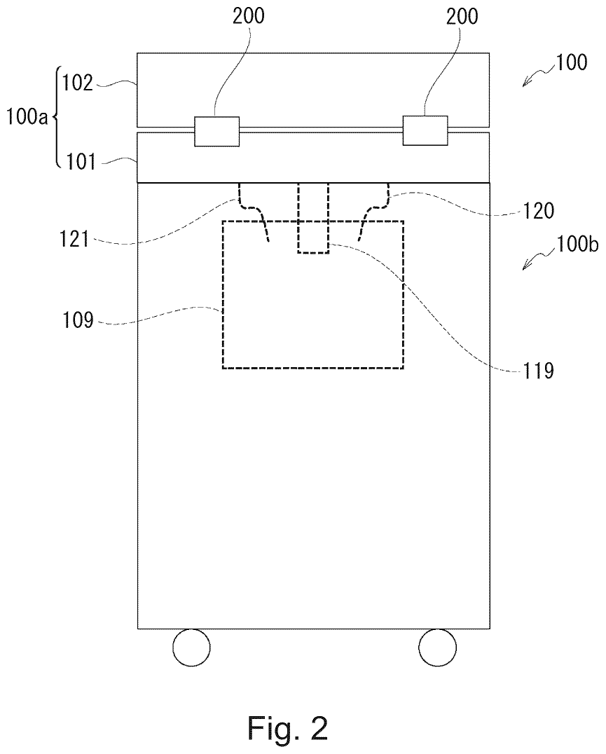

FIG. 2 is a view of the image forming apparatus 100 as seen from the back side. Inside the back side of the image forming main apparatus 100b, a controller substrate 109, which is a control portion which controls the image reading apparatus 100a and the image forming main apparatus 100b, is disposed. To the controller substrate 109, cables such as a flat cable 119, a motor cable 120 and a sensor cable 121, which will be described below, are connected. The controller substrate 109 is capable, based on the image data of the original read by the image reading apparatus 100a, of executing the image forming process described above.

Incidentally, the configuration of the image forming main apparatus 100b described above is an example, and may be changed in various ways. For example, it may be a configuration which directly transfers the toner image from the developing portion to the sheet, and a configuration which performs a monochrome image formation. Furthermore, it may be a configuration provided with a manual feed tray to which the sheet is manually fed.

### Outline Configuration of the Image Reading Apparatus

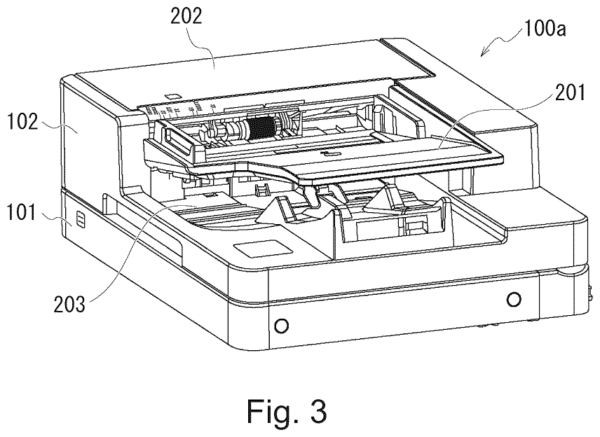

Next, an outline configuration of the image reading apparatus 100a will be described using FIG. 3. FIG. 3 is a perspective view illustrating the image reading apparatus 100a according to the present embodiment.

As described above, the image reading apparatus 100a is constituted by the image reading main apparatus 101 and the ADF 102. The ADF 102 is arranged to be openable and closable, by two hinges 200 (see FIG. 2), with respect to the image reading main apparatus 101. The two hinges 200 are fixed to the back side of the image reading main apparatus 101, and rotational axes of the two hinges 200 are extending in the left-right direction.

The ADF 102 includes an original tray 201 on which the original is stacked, an original conveyance portion 202 which conveys the original stacked on the original tray 201, and an original discharge tray 203 to which the original is discharged. The original conveyance portion 202 conveys the original stacked on the original tray 201 toward a flow reading glass 113, which will be described below. As for the original conveyed by the original conveyance portion 202, upon passing through an upper surface of the flow reading glass 113, the image thereof is read by a reading unit 114.

Thereafter, the original of which the image has been read is discharged to the original discharge tray 203. Incidentally, the ADF 102 may have a configuration which is provided with a separate reading unit therein other than the reading unit 114 and capable of reading the images on both sides of the original in a single conveyance.

### Configuration of the Image Reading Main Apparatus

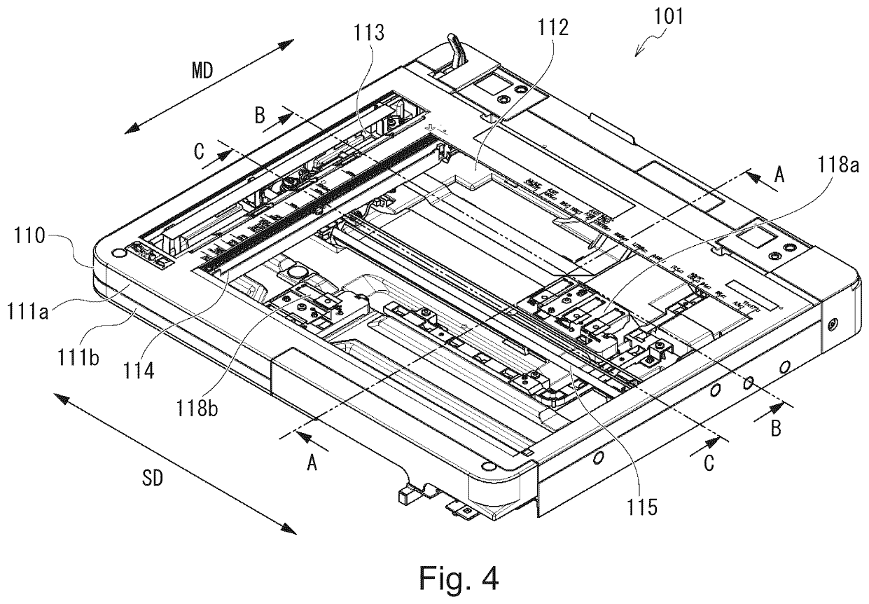

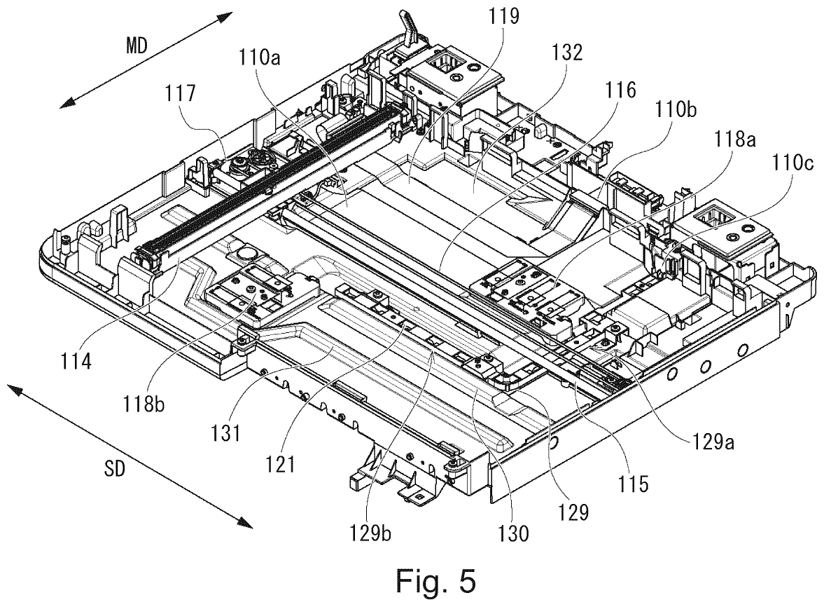

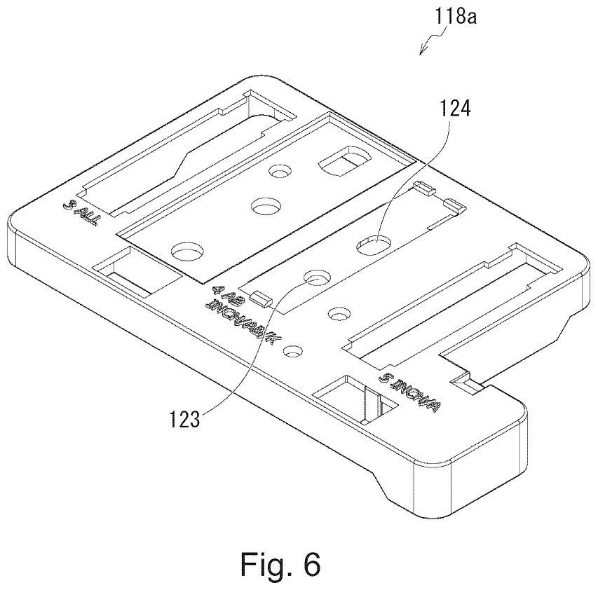

Next, a configuration of the image reading main apparatus 101 will be described using FIG. 4 through FIG. 6. FIG. 4 is a perspective view of the image reading main apparatus 101. FIG. 5 is a perspective view of the image reading main apparatus 101 in a state in which a top cover 111a of a housing 110 is removed. FIG. 6 is a perspective view of a size detecting sensor 118a.

The image reading main apparatus 101 is provided with the housing 110, the original table glass 112 and the flow reading glass 113. In addition, as shown in FIG. 5, inside the housing 110, the reading unit 114, a guide shaft 115, a driving belt 116, a driving motor 117, the size detecting sensor 118a, a size detecting sensor 118b, etc. are disposed.

The housing 110 is constituted by the top cover 111a and a bottom cover 111b, which are made of resin, and accommodates the reading unit 114 and a driving mechanism for driving the reading unit 114 inside thereof. The housing 110 supports the original table glass 112 and the flow reading glass 113, and on an upper surface of the top cover 111a, the original table glass 112 and the flow reading glass 113 are arranged to be exposed. The original table glass 112 is an example of a transparent member.

The reading unit 114 is a contact image sensor (CIS) which includes a light receiving element arranged in a main scanning direction MD, a light source which illuminates a light onto the original, a lens which guides a light from the original to the light receiving element, etc. In addition, the guide shaft 115 is disposed extending in a sub scanning direction SD perpendicular to the main scanning direction MD, and supports the reading unit 114 movably in the sub scanning direction SD. The driving belt 116 is stretched over pulleys so as to be along the guide shaft 115, and the reading unit 114 is fixed to a predetermined position in the driving belt 116. The driving belt 116 is connected to the driving motor 117, and by the driving belt 116 being rotated by the driving motor 117, the reading unit 114 is moved in the sub scanning direction SD along the guide shaft 115. Incidentally, in the present embodiment, the main scanning direction MD is a direction parallel to the depth direction of the image forming apparatus 100, and the sub scanning direction SD is a direction parallel to the left-right direction.

The image reading apparatus 100a can read the image of the original in two ways of a fixed reading and a flow reading. In a case of the fixed reading, a user sets the original on the original table glass 112. At this time, the user opens the ADF 102 to expose the original table glass 112, closes the ADF 102 after stacking the original on the original table glass 112, and fix the original at a predetermined position on the original table glass 112. In the state in which the original is set on the original table glass 112, the reading unit 114 reads the image of the original while being moved in the sub scanning direction SD. When the reading of the original is completed, the user opens the ADF 102 and takes out the original from the original table glass 112.

On the other hand, in the case of the flow reading, the user sets the original on the original tray 201. At this time, the original set on the original tray 201 may be plural. The original conveyance portion 202 conveys the original stacked on the original tray 201 toward the flow reading glass 113 one by one. In the flow reading, the reading unit 114 is stopped below the flow reading glass 113, and reads the image of the original via the flow reading glass 113. Thereafter, the original of which the image has been read is discharged to the original discharge tray 203.

Inside the housing 110, the two size detecting sensors 118a and 118b are disposed for detecting a size of the original set on the original table glass 112 upon the fixed reading. The size detecting sensor 118a is disposed at a position on the back side than the guide shaft 115 and on the right side than a center of the apparatus, and the size detecting sensor 118b is disposed at a position on the front side than the guide shaft 115 and on the left than the center of the apparatus. In other words, the two size detecting sensors 118a and 118b are disposed across the guide shaft 115 in the depth direction.

FIG. 6 is a perspective view of the size detecting sensor 118a. As shown in FIG. 6, the size detecting sensor 118a is provided with a light emitting portion 123 which emits infrared rays above the sensor and a light receiving portion 124 which receives infrared rays reflected from the original above the sensor. The size detecting sensor 118a detects presence or absence of the original at the position where the sensor is disposed based on a light amount the light receiving portion 124 receives. Incidentally, the size detecting sensor 118b also has the same configuration as the size detecting sensor 118a.

The size detecting sensor 118a is mainly used to determine whether or not the original is longer than a predetermined length in the main scanning direction MD. In addition, the size detecting sensor 118b is mainly used to determine whether or not the original is longer than a predetermined length in the sub scanning direction SD. The controller substrate 109 is capable of determining the size of the original set on the original table glass 112 based on signals from these two size detecting sensors 118a and 118b.

By this, it becomes possible for the controller substrate 109 to execute copying and/or scanning with appropriate standard sizes (A4 size, A3 size, etc.).

### Arrangement of the Cables Inside the Housing

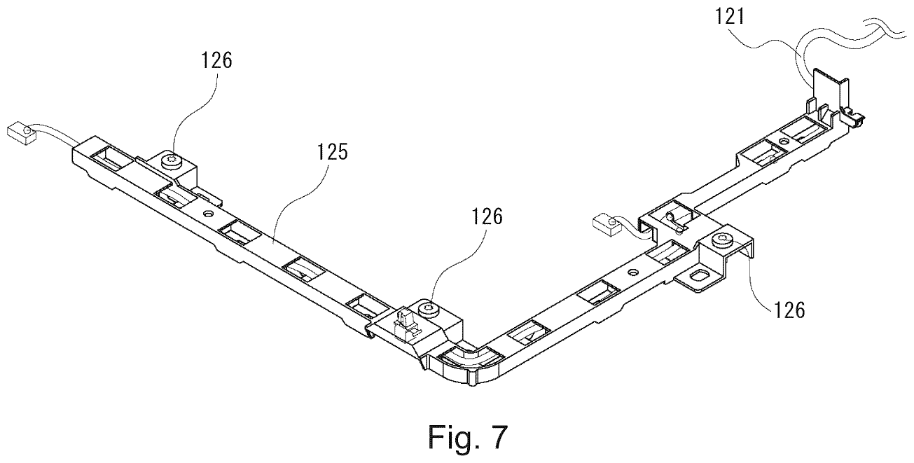

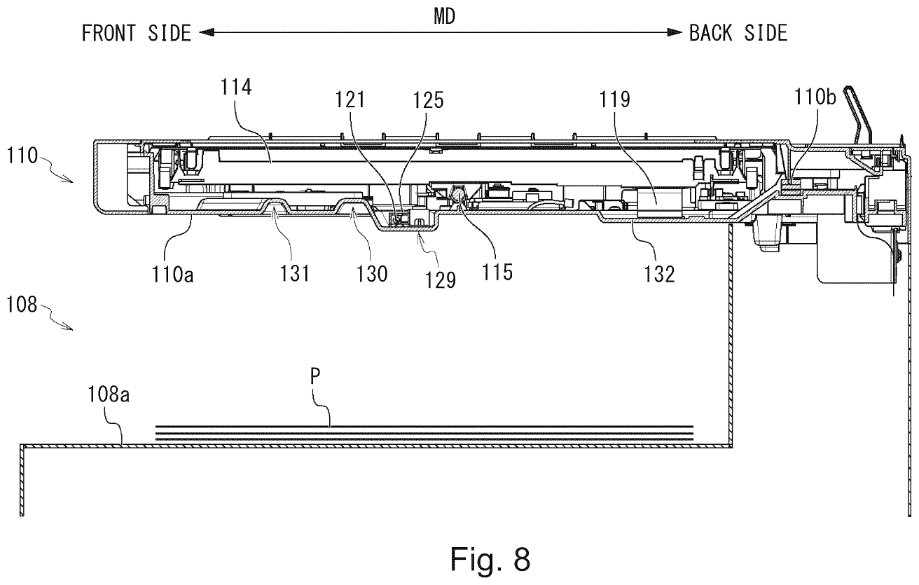

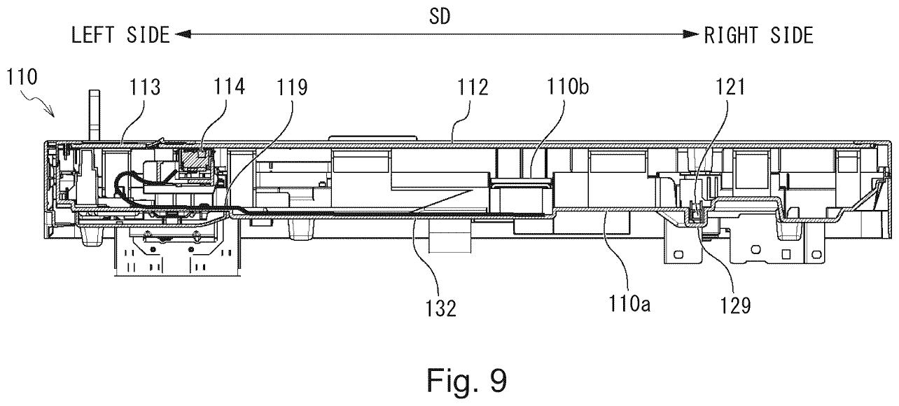

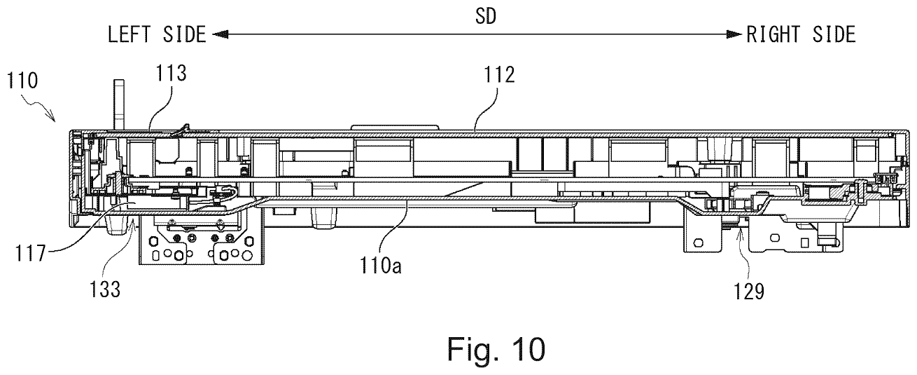

Next, arrangement of the cables inside the housing 110 will be described using FIG. 7 through FIG. 10. FIG. 7 is a perspective view of the sensor cable 121 and a cable guide 125. FIG. 8 is a cross-sectional view of the discharging portion 108 and the image reading main apparatus 101 as viewed in the sub scanning direction SD, and is an A-A cross-sectional view of FIG. 4. FIG. 9 is a cross-sectional view of the image reading main apparatus 101 as viewed in the main scanning direction MD, and a B-B cross-sectional view of FIG. 4. FIG. 10 is a cross-sectional view of the image reading main apparatus 101 as viewed in the main scanning direction MD, and is a C-C cross-sectional view of FIG. 4.

A plurality of the cables are routed inside the housing 110, and these cables are connected to the controller substrate 109, which is disposed outside the housing 110, via a plurality of holes (hole portions 110b and 110c) formed on a side surface of the housing 110. As for the flat cable 119, one end thereof is connected to the reading unit 114, and the other end thereof is connected to the controller substrate 109. The flat cable 119 supplies electric power to the reading unit 114, and transfers a signal of the image of the original read by the reading unit 114 to the controller substrate 109. The flat cable 119 includes a flat surface, is disposed inside the housing 110 so that the flat surface contacts a bottom surface 110a of the housing 110 (a bottom surface of the bottom cover 111b), and is exposed outside the housing 110 through the hole portion 110b formed in the housing 110. The flat cable 119 is deformed, along with the moving of the reading unit 114, while being curved inside the housing 110.

As for the motor cable 120, one end thereof is connected to the driving motor 117, and the other end thereof is connected to the controller substrate 109. The motor cable 120 supplies electric power to the driving motor 117, and transfers a control signal from the controller substrate 109 to the driving motor 117.

As for the sensor cable 121, one end thereof is connected to the controller substrate 109, and the sensor cable 121 is split into two in the middle, and the split end portions are connected to the size detecting sensors 118a and 118b, respectively. The sensor cable 121 supplies electric power to the size detecting sensors 118a and 118b, and transfers the signals from the size detecting sensors 118a and 118b to the controller substrate 109. Of the two sensors, the size detecting sensor 118b is disposed on the front side than the guide shaft 115, so that the sensor cable 121 is connected to the size detecting sensor 118b from the hole portion 110c passing below the guide shaft 115.

As shown in FIG. 7, the sensor cable 121 is arranged to pass through inside the cable guide 125. The cable guide 125 is a member, inside which a space for the cable to pass through is formed, made of resin having an elongated shape. The cable guide 125 is fixed to the bottom surface 110a of the housing 110 by screws 126 at a plurality of locations. In this manner, by providing the cable guide 125 which guides the sensor cable 121, it becomes possible to prevent the sensor cable 121 from contacting the reading unit 114 and/or the driving belt 116 and being broken. The sensor cable 121 is an example of a first cable, and the flat cable 119 is an example of a second cable.

As shown in FIG. 5 and FIG. 8, in the bottom surface 110a of the housing 110, groove portions 129 and 132, which are recessed downward from peripheries thereof, respectively, are formed. The groove portions 129 and 132 have forms which are recessed downward from the peripheries thereof as viewed from above, and protrude downward from the peripheries thereof as viewed from below (the lower surface 101a side of the image reading main apparatus 101). The groove portion 129 has an elongated shape extending from the hole portion 110c, passing below the guide shaft 115, to the size detecting sensor 118b. Specifically, the groove portion 129 is constituted by a first part 129a extending in the main scanning direction MD (depth direction) so as to pass below the guide shaft 115, and a second part 129b extending along the sub scanning direction SD (left-right direction). The second part 129b is formed continuously from an end portion on the front side of the first part 129a. The sensor cable 121 and the cable guide 125 described above are arranged to pass through inside the recess of this groove portion 129.

The groove portion 132 has a shape extending from the hole portion 110b to the left side in the sub scanning direction SD (left-right direction), and is formed on the back side than the guide shaft 115. In addition, the groove portion 132 is formed in an area on the left side than the first part 129a of the groove portion 129 in the bottom surface 110a. The flat cable 119 is arranged to pass through inside the recess of the groove portion 132. Incidentally, the flat cable 119 is wider than the sensor cable 121, and is deformed along with the moving of the reading unit 114, so that the groove portion 132 has a groove shape wider than the groove portion 129 (see FIG. 8). The groove portion 129 is an example of a first groove portion, and the groove portion 132 is an example of a second groove portion.

Furthermore, in the bottom surface 110a of the housing 110, two protruding portions 130 and 131, which are ribs extending in the sub scanning direction SD (left-right direction), are formed. These protruding portions 130 and 131 have shapes protruding upward as viewed from above, and have shapes recessed upward from peripheries thereof as viewed from below (the lower surface 101a side of the image reading main apparatus 101). The protruding portions 130 and 131 are formed, in the main scanning direction MD (depth direction), on the front side than the groove portions 129 and 132 described above. Since the housing 110 is formed of resin, compared to a case in which the housing is formed of a sheet metal, strength of the housing itself becomes less. Thus, in the present embodiment, by the protruding portions 130 and 131 being formed on the bottom surface 110a of the bottom cover 111b, it becomes possible to increase the strength of the housing 110.

In addition, as shown in FIG. 10, in the bottom surface 110a of the housing 110, a recessed portion 133, which is recessed downward from a periphery thereof, is formed. The recessed portion 133 is formed on the back side than the guide shaft 115 in the depth direction and at a position of a left end portion in the left-right direction, and the driving motor 117 is disposed inside the recess of the recessed portion 133. The recessed portion 133 has, unlike the groove portions 129 and 132 described above, a rectangular shape as viewed from above.

As shown in FIG. 9, in a case in which the reading unit 114 is positioned on the left side than a center of the housing 110 in the left-right direction, the flat surface of the flat cable 119 is in a state of contacting approximately an entire area of the groove portion 132 in the left-right direction. When the reading unit 114 is moved to the right direction from this state, the flat cable 119 is curved so as to be lifted starting from the left side. And, when the reading unit 114 is moved to an end portion on the right side, the flat cable 119 comes to be in a shape as crossing above the sensor cable 121. At this time, if the flat cable 119 and the sensor cable 121 come into contact with each other, risk of reading defect and/or wire breakage arises. However, in the present embodiment, the sensor cable 121 is disposed inside the groove portion 129. By this, a distance between the flat cable 119 and the sensor cable 121 is increased, so that it becomes possible to reduce the contact between the flat cable 119 and the sensor cable 121.

In addition, in the present embodiment, the cable guide 125 which guides the sensor cable 121 is disposed inside the groove portion 129, and the sensor cable 121 is routed passing through inside the cable guide 125. By this, it becomes possible to reduce further the contact between the flat cable 119 and the sensor cable 121.

In addition, upon the reading unit 114 being moved, if the reading unit 114 and the flat cable 119 come into contact with each other, risk of the reading defect and/or the wire breakage arises. However, in the present embodiment, the flat cable 119 is arranged to pass through inside the groove portion 132. By this, a distance between the reading unit 114 and the flat cable 119 is increased, so that it becomes possible to reduce the contact between the reading unit 114 and the flat cable 119.

In order to reduce the contact between the flat cable 119 and the sensor cable 121 and the contact between the reading unit 114 and the flat cable 119, a configuration in which the housing 110 is made to be larger in its height direction by lowering an entirety of the bottom surface 110a of the housing 110 can be considered. However, in such a configuration, an entirety of the lower surface 101a of the image reading main apparatus 101 becomes lower, and the space in the discharging portion 108 becomes narrower, so that it becomes difficult for a user to take out the sheet P from the discharge tray 108a. Thus, in the present embodiment, instead of lowering the entirety of the bottom surface 110a, it is configured that the bottom surface 110a has the groove portions 129 and 132 which is partially recessed from the peripheries thereof, and the flat cable 119 and the sensor cable 121 are routed therein. By this, it becomes possible to make the space in the discharging portion 108 wider than the configuration in which the entirety of the bottom surface 110a is lowered, and make it easier for a user to take out the sheet P from the discharge tray 108a.

In addition, in the present embodiment, the protruding portions 130 and 131 for enhancing the strength of the housing 110 are formed on the front side than the groove portions 129 and 132. As shown in FIG. 8, as viewed from the lower surface 101a side (downside) of the image reading main apparatus 101, the groove portions 129 and 132 have shapes protruding downward, and the protruding portions 130 and 131 have shapes recessed upward. Therefore, the protruding portions 130 and 131 do not cause the space of the discharging portion 108 to be narrowed. If, to the contrary to the present embodiment, the groove portions 129 and 132 were formed on the front side than the protruding portions 130 and 131, the protrusions of the groove portions 129 and 132 would be positioned on the front side of the space of the discharging portion 108, so that it becomes difficult for a user to take out the sheet P from the discharge tray 108a. However, in the present embodiment, since the protruding portions 130 and 131 are formed on the front side than the groove portions 129 and 132, the space on the front side of the discharging portion 108 becomes wider, so that it becomes possible to make it easier for a user to take out the sheet P from the discharge tray 108a.

In addition, in the present embodiment, the recessed portion 133 is formed in the bottom surface 110a of the housing 110, and the driving motor 117 is disposed inside this recessed portion 133. In a case in which the driving motor 117 is disposed inside the housing 110, it is desirable that the driving motor 117 be disposed lower than the guide shaft 115 so as to be able to be connected to the driving belt 116. Therefore, a configuration in which the driving motor 117 is disposed by lowering the entirety of the bottom surface 110a of the housing 110 can be considered. However, as described above, in such a configuration, it becomes difficult for a user to take out the sheet P from the discharge tray 108a. On the other hand, in the present embodiment, instead of lowering the entirety of the bottom surface 110a, it is configured that the recessed portion 133 is formed in a part of the bottom surface 110a, and the driving motor 117 is disposed therein. Therefore, it becomes possible to make the space in the discharging portion 108 wider than the configuration in which the entirety of the bottom surface 110a is lowered, and it becomes possible to make it easier for a user to take out the sheet P from the discharge tray 108a. In addition, by the recessed portion 133 being formed on the back side than the guide shaft 115, the space on the front side of the discharging portion 108 becomes wider, and it becomes possible to make it further easier for a user to take out the sheet P from the discharge tray 108a.

According to the present disclosure, in the image forming apparatus in which the upper surface of the discharging portion is constituted by the lower surface of the image reading apparatus, it becomes possible to make it easier for a user to take out the sheet from the discharging portion.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-199918 filed on Nov. 15, 2024, which is hereby incorporated by reference herein in its entirety.

What is claimed is:

1. An image forming apparatus comprising:
a main apparatus configured to form an image on a sheet; and
an image reading apparatus configured to read an image on an original,
wherein the main apparatus is provided with
an image forming unit configured to form the image on the sheet, and
a discharge tray on which the sheet, on which the image is formed by the image forming unit, is stacked,
wherein the image reading apparatus is provided with
a transparent member on which the original is stacked,
a reading unit configured to read the image of the original stacked on the transparent member,
a housing configured to support the transparent member and to accommodate the reading unit,
a sensor disposed on a bottom surface of the housing and configured to detect the original stacked on the transparent member, and
a cable connected to the sensor,
wherein a lower surface of the bottom surface is positioned above the discharge tray and forms an upper portion of a discharge space to which the sheet, on which the image is formed by the image forming unit, is discharged,
wherein in the bottom surface of the housing, a groove portion which is recessed downward inside the housing and protrudes in the discharge space is formed, and
wherein the cable is arranged to pass through inside the groove portion.

2. The image forming apparatus according to claim 1, wherein the housing is formed of a resin.

3. The image forming apparatus according to claim 1, wherein the image reading apparatus is disposed inside the housing and is provided with a shaft movably supporting the reading unit, and
wherein as viewed from above, at least a part of the groove portion is overlapped with the shaft.

4. The image forming apparatus according to claim 3, wherein the shaft is disposed along a left-right direction of the image forming apparatus in which the reading unit moves,
wherein the sensor is disposed on a front side of the shaft with respect to a depth direction of the image forming apparatus perpendicular to the left-right direction, and
wherein the groove portion includes a first part extending to the depth direction so as to pass below the shaft, and a second part continuously formed from the first part in the front side of the shaft and extending to the left-right direction.

5. The image forming apparatus according to claim 1, wherein in the bottom surface of the housing, a protruding portion protruding upward inside the housing and extending in a left-right direction of the image forming apparatus in which the reading unit moves is formed, and
wherein the protruding portion is disposed on a front side of the groove portion with respect to a depth direction of the image forming apparatus perpendicular to the left-right direction.

6. The image forming apparatus according to claim 1, wherein the cable is a first cable and the groove portion is a first groove portion,
wherein the image reading apparatus includes a second cable connected to the reading unit and configured to transfer a signal of the image read by the reading unit to a control portion,
wherein in the bottom surface of the housing, a second groove portion which is recessed downward inside the housing and protrudes in the discharge space is formed, and
wherein the second cable is arranged to pass through inside the second groove portion.

7. The image forming apparatus according to claim 6, wherein the second cable is a flat cable including a flat surface, and
wherein a width of the second groove portion is wider than a width of the first groove portion.

8. The image forming apparatus according to claim 1, wherein the image reading apparatus includes a cable guide configured to guide the cable, and
wherein the cable guide is disposed inside the groove portion.

9. The image forming apparatus according to claim 1, wherein the image reading apparatus is provided with
a shaft extending in a left-right direction of the image forming apparatus and configured to movably support the reading unit, and
a driving motor and a driving belt configured to move the reading unit in the left-right direction,
wherein in the bottom surface of the housing, a recessed portion which is recessed downward groove portion which is recessed downward on a front side of the shaft in a depth direction of the image forming apparatus perpendicular to the left-right direction, and
wherein the driving motor is disposed in the recessed portion.

10. An image reading apparatus disposed on an upper portion of an image forming apparatus which forms an image on a sheet and discharges the sheet to a discharge space, and for reading an image of an original, the image reading apparatus comprising:
a transparent member on which the original is stacked,
a reading unit configured to read the image of the original stacked on the transparent member,
a housing configured to support the transparent member and to accommodate the reading unit,
a sensor disposed on a bottom surface of the housing and configured to detect the original stacked on the transparent member, and
a cable connected to the sensor,
wherein a lower surface of the bottom surface forms an upper portion of the discharge space,
wherein in a bottom surface of the housing, a groove portion which is recessed downward inside the housing and protrudes in the discharge space is formed, and
wherein the cable is arranged to pass through inside the groove portion.
